(19) United States
(12) Patent Application Publication
(10) Pub. No.: US 2004/0015810 A1
(43) Pub. Date: Jan. 22, 2004

(54) Method for the improved provision of medical services

(76) Inventor: Robert S. Swinney, Altadena, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 09/863,521

(22) Filed: May 23, 2001

(51) Int. Cl. G06F 9/44

(52) U.S. Cl. 717/100; 706/924

(57) ABSTRACT

Patient diagnosis and treatment information is sent to a transcribing service which transcribes the information and transmits it to a research engine. The research engine receives the transcription and provides information relevant to the patient's diagnosis or treatment. This information can be sent directly to the physician or sent to the transcribing service to be provided to the physician with the transcription. The relevant information assists physicians treat the current patient and patients in the future.

### BACKGROUND OF THE INVENTION

1. Field of the Invention

The present invention relates to the field of medicine and, in particular, to the field of medical methodologies regarding the process of automatic provision of patient-specific information for a physician or other healthcare worker to use in delivering care to a patient.

2. Description of the Related Art

Advances in medicine occur daily. Incorporating these advances into a physician's or other healthcare worker's practices is difficult and slow because of the large volume of new information, the breadth of the subject matter to be followed, time constraints of a demanding physician's practice, and difficulty in changing a physician's entrenched habits. The logistics for providing a physician to acquire and integrate the large volume of new information which is developed daily are daunting. Many intervention programs for providing physicians with up-to-date information have been studied and implemented, such as continuing medical education (CME) courses, hospital conferences and presentations, printed monographs, and CME home reading materials. These interventions have shown to have a disappointingly small impact on changing the day-to-day to day practices of physicians and healthcare workers. Consequently, current and future patients are deprived of the benefits of new practices that have been shown to be efficacious.

Most importantly, current methods of information delivery fail to utilize the most potent learning and practice changing paradigm known: the learning that is associated with the experience of caring for an individual patient. For example, reading that aspirin might benefit a specific patient, such as a Mr. Jones, who is currently in the Intensive Care Unit after suffering a heart attack, is a much more powerful experience and learning tool than hearing a lecture on studies that show the benefits of aspirin for heart attack victims in general. Physicians and healthcare workers and others tend to retain more information when it is learned and used while treating a specific patient, rather than by encountering general studies that are not patient-specific. By analogy, an individual is far more likely to learn how to change a flat tire if that individual changes the tire himself while being tutored as opposed to just watching a video of a tire being changed.

Investigations into “real world” aspects of new information acquisition have noted that many of the typical physician's 20-30 daily patient encounters generate clinical questions, the current best answers to which the physician oftentimes does not know. Optimal care, therefore, requires some type of research in order to answer these unanswered questions. Direct observation of primary care physicians has shown that an average of two questions are generated for every three patient encounters. These questions, for the most part, are “patient-specific,” meaning that the question arises in regard to an individual patient's problem. The answer, when available, is applicable to the specific patient, and, perhaps more valuably, applicable to numerous patients the physician encounters in the future. Unfortunately, approximately two-thirds of the clinical questions generated at the point of care go unanswered because of the time and extensive effort needed to research the answers. One study presented unanswered questions to medical librarians who then returned the answers to the physicians who had asked them. It was found that approximately one-half of the answers would have resulted in a change in that patient's care.

Another less obvious, but more problematic, drawback with prior art methods is that questions that need to be asked are not being asked. This occurs in situations, for example, where the physician treats a specific problem in patient after patient in essentially the same way without ever stopping to ask “what is the current best treatment for this condition?” Thus, patients get treated by physicians out of habit or based on old information as opposed to the physician obtaining the most recent information on treating the condition. No physician, even the most dedicated and conscientious, can investigate the best treatment for each specific condition in connection with each patient he or she sees each day.

A simple example is in the problem of corneal abrasions. For years, part of the treatment of corneal abrasions has been the application of a firm eye patch for several days. This standard approach is not based on any evidence of efficacy. A 1960 study evaluated differences in healing of corneal abrasions comparing patients wearing an eye patch with patients not wearing such a patch. Several more recent studies have supported the recommendation to avoid patching the eye of patients with simple corneal abrasions because those who did not receive an eye patch have less pain and healed faster. Despite this information, many doctors, unaware of the newer data, continue treating corneal abrasions in the “standard” way, with eye patches. The end result—suboptimal care—is the same whether the physician failed to ask the question, or did ask, but failed to receive the answer in a timely fashion.

Another example involves a recent consensus recommendation that is not being adequately implemented relating to the treatment of asthma. Although it is well documented that inhaled steroids work best to reduce morbidity and mortality, a large percentage of children with asthma are not being treated in this way. Even though other factors may play a role, this situation is primarily caused by a lack of questions being asked and/or a lack of questions being answered. Numerous other important examples (e.g., the use of beta blockers in patients with heart attacks) exist.

Of the questions that are actually pursued and answered in the limited time a physician has for research, many of the answers are found in questionable or outdated sources. Over half come from text books that are three or more years old or from human sources such as office partners and consultants. Regrettably, human sources vary widely in their reliability, as they are prone to the same flaws of giving advice based on habit and/or obtaining information or knowledge from outdated sources. More reliable sources are original scientific articles in medical journals and consensus statements from recognized local or national societies and associations. Too often these sources are not consulted for their valuable current data.

Several reasons exist to explain why physicians are not receiving the most recent information necessary to optimally treat a patient. One major reason is, of course, time restraints. Physicians often see 20 to 30 patients per day and do not have the time available to manually research each question asked of them or to ask new questions to confirm that the treatment of a specific patient is carried out in view of the most recent or relevant information available. Even more important, however, is the issue of the process or logistics of obtaining needed information. To obtain pertinent current information requires first that a physician stop and think of all relevant questions to be asked, and second that he or she take the time to ask the question and obtain an answer. As to the first requirement, it has already been noted that physicians cannot reasonably ask a question regarding every clinical circumstance encountered. Only those circumstances about which the clinician senses some uncertainty are likely to stimulate an inquiry in his or her mind. Thereafter, with regard to the second issue, the degree of uncertainty and the perceived criticality of resolving the uncertainty must be sufficient to warrant undertaking the substantial effort necessary to seek an answer to a question.

Information that physicians need to optimize their care of patients is not now connected to the information that physicians produce to carry out their care of patients. In prior art methods, physicians currently produce a record of their interactions with patients in the form of a handwritten or dictated then transcribed notation. The purpose of the production of these records is almost entirely to communicate with other care givers and to document the physician's activities for legal, financial and other activities or concerns. These recordations contribute almost nothing to the enhancement of knowledge of the physician, and nothing occurs in this process to change the physician's future treatment of patients. Thus, a physician's analytical output that occurs as a result of an individual patient encounter becomes little more than a transiently useful messaging mechanism and a way to document the actions taken by the physician. There are rarely any benefits or feedback to the physician—for the current or for future patients—based on his or her input.

Thus, there is a need in the medical services field for connecting the handwritten or dictated then transcribed notations of the physician with useful, up-to-date, patient-specific information which will assist the physician in providing care for patients.

The phenomenon of a “feedback” mechanism is well understood in medicine (e.g., when the blood sugar rises, more insulin is “automatically” secreted to lower the blood sugar). Currently, no such mechanism exists to provide “automatic feedback” to the physician to enable the physician to provide better care to patients based on up-to-date, current and relevant information.

### SUMMARY OF THE INVENTION

Thus, a need exists for an improved system to “feedback” information to the physician that is specific and relevant for each individual patient and each individual patient's problem. The present invention accomplishes this through an effective and efficient methodology for information delivery that overcomes the drawbacks of the prior art. The method of this invention provides for the automatic delivery of information that is specifically applicable to an individual patient, based on information about that patient that exists as a result of a physician's documentation of the patient's medical circumstances. This (routine) documentation of patient care is the initiating event that results in information feedback. Unlike prior art methods wherein the physician must explicitly request information, the current invention provides for information to be relayed to the physician without any such explicit request because the information will be provided automatically as a by-product of the routine documentation process.

In the present invention, the physician's record of his or her encounter with the patient, which typically includes a description of the patient's symptoms, and physician's findings, assessment and planned care, is processed by dictation and transcription or entered directly into a computer system so that it is available for electronic processing by a “research engine.” The physician does not request information retrieval and in fact need not be aware that any information will be provided to him or her. The research engine proceeds automatically to process this incoming data and then returns information that is relevant to the information provided by the physician. The output from the research engine is transmitted back to the physician as an addition or addendum to the patient-related information received by the research engine. Thus, without an explicit request from a physician, that physician receives potentially new and valuable information that he or she may use in connection with the care of the current and/or future patients. Thus, without a physician performing any additional work, he or she receives important, new and valuable information to improve patient care

### BRIEF DESCRIPTION OF THE DRAWINGS

FIG. 1 schematically illustrates the pathway of information flow between the patient, the physician, the medical transcriptionist, and the research engine in the preferred embodiment.

### DETAILED DESCRIPTION OF THE PREFERRED EMBODIMENTS

The present invention is an automated system for medical practices providing a way for more effective delivery of relevant information and education of practicing physicians and other caregivers and ultimately for long-term improvement to the way medicine is practiced. The system is essentially a few added steps to the process of the physician's documentation of his or her patient care activity. Commonly this process flow is as follows: after a patient visit, the physician typically dictates his or her findings and/or diagnoses. The dictated information is typically transferred to a medical transcriptionist or medical transcription company, where the dictation is transformed into text which is then transferred back to the physician for his or her records. At this point, the physician, upon approving the transcription, would manually or electronically sign the transcribed information after which the information would be added to the patient's medical record.

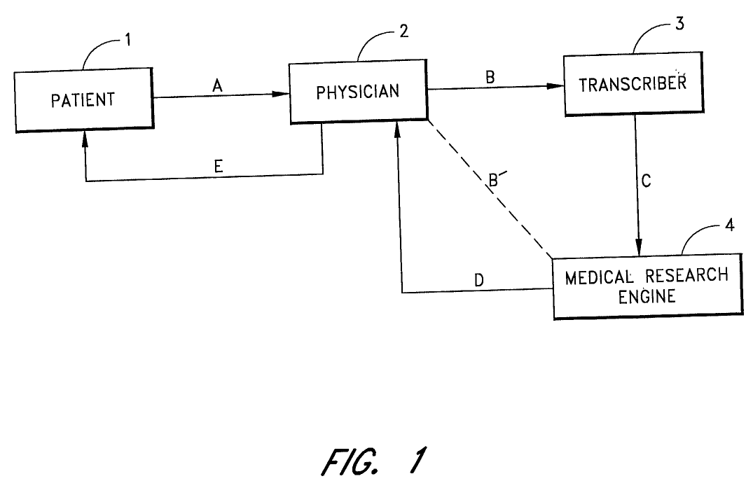

The present invention, however, adds a few steps to the process that creates an opportunity not only for educating the physician, but also for potentially having a significant impact on the patient's care. FIG. 1 is a schematic drawing showing the information flow that would occur in the preferred embodiment of the present invention. The patient 1 provides information A that relates to the patient's complaint, illness, medical history, etc., to the physician 2. The physician 2 then processes this information mentally and records pertinent data such as the history, physical findings, the diagnosis, and the plan, via dictation or other means including, but not limited to, direct input into a computer or handwritten form. The physician 2 then transfers this information B to a transcriber 3 who is preferably trained in medical vocabulary and in interpreting medical dictation, and can transform this information into a coherent text which can be transferred electronically. The coherent text or transcription C is then preferably transferred from the transcriber 3 to a medical research engine 4. The transfer of the transcription C may occur automatically via computer, via telephone line, manually or any other way known to transfer information which will be easily understood by those of skill in the art. The research engine 4 advantageously extracts pertinent information from the transcription C and conducts a search for the most recent or pertinent or relevant findings, medical guidelines or other information that would be educational and informative to the physician regarding the specific case. (Some of this information may be recent, although other pertinent and relevant information may have been generated years ago.) The transcription C in addition to the research results D would then be transferred back to the physician 2 in the shortest period of time to allow for modification of the diagnosis/treatment plan, or at the very least for educational purposes. As soon as the physician 2 reviews the transcription C along with the data provided from the research engine D the physician would be informed that there is new information on that specific case, which the physician 2 can quickly access and read. This new information could be incorporated into the physician's practice and could be translated into better methods and treatments E which would be provided to the patient as appropriate. The transcription C plus new, relevant and/or pertinent information D could be important to a physician's education, enlightenment, and result in modifications to the physician's practice which would be important for the care of the physician's future patients. In addition, the timely availability of this “best practice information” D provided along with the transcription C could be critical to the care provided to the physician's current patient.

As an alternative, the physician could transfer information B′ directly to the research engine 4, and the subsequent research information D could be sent directly back to the physician 2. This may be the case if the physician 2 directly inputs information into a computer.

Although the transcription of information is discussed above, the present invention contemplates information being transferred by any one of a number of means. For example, the physician may transfer information to the transcriber 3 in handwritten form by courier or via facsimile. Alternatively, information can be transferred directly by computer, by communication of transcription units at remote locations, or by any communication means known to those of skill in the art.

On the most general level, the present invention encompasses the automation, from the physician's point of view, of the process of obtaining researched information. In other words, the physician sees the patient, records the findings, diagnosis, and treatment, sends this information to be transcribed, and when the transcription is returned, the physician has access to the most updated, useful, relevant and pertinent information available specifically tailored to the patient and the patient's problem. Although this may require the work of several people and/or computers, from the physician's perspective, the research process has been automated, i.e., the physician automatically receives this patient-specific information without the physician incurring additional steps or expending any effort beyond the current documentation process routinely used by the physician today.

There are many ways in which the method of the present invention can be accomplished. The general formula, however, which is a constant in the preferred embodiments, is summarized in the following sentence: The physician's notes, in whatever form they originally take (i.e., dictation, handwritten notes, electronic notepad, stored by a computer, typewritten, etc.) are transferred to an electronic text format, are sent to a research engine, and then sent back to the physician along with the most recent, relevant and pertinent research information in the most effective and timely fashion possible. Broken down slightly further, this process may comprise five overall steps.

The first step is the transfer of the physician's patient care documentation from its original format, whatever format that may be, to one that can be transferred or transmitted. Preferably, this format is electronic in nature and the physician's documentation is transcribed into electronic text. Of course, the physician may enter the documentation into a computer or directly into an electronic text format. The second step is the transfer of the documentation, preferably in electronic form, to a research engine. The third step is that the research engine would find and process all pertinent, relevant and key information from the physician's documentation, and use that information to conduct a search for useful information relating to medical care for a specific patient. The fourth step is the transfer of that research information back to the physician in a timely fashion, along with the documentation, based upon which the research was conducted. Preferably, this transfer occurs electronically. The fifth and final step is bringing the researched information directly to the physician's attention by an efficient and effective manner, such that the physician can quickly and easily access and use the information to treat current and/or future patients. Of course, as will be easily understood by those of skill in the art, each of the above outlined steps can occur in multiple ways, some of which will be described below.

The first step normally occurs via a professional medical transcriptionist. The physician, in one embodiment, may see a patient and record a note via a dictation device or over the telephone. Alternatively, the physician may enter the information into a computer or take handwritten notes. Of course, as will be understood by those of skill in the art, a physician may record information at other times without seeing a patient. For example, a physician may record information after reading a patient's x-rays or after reviewing a patient's file. Indeed, whenever a physician is evaluating, contemplating, observing, diagnosing or taking other action in connection with providing medical services, he or she may record information which may be used in connection with the present invention. In accordance with a preferred approach, the physician uses a dictation device which is then deposited in a conveniently located information transmitter that automatically downloads and sends the physician's information to a transcription service; however, the present invention contemplates any mode of recording information and transferring that information to the transcriber 3 or research engine 4.

Traditionally, if the physician dictates the information, a transcriptionist transcribes the dictated speech into an electronic format. The information may contain specifics relating to the patient's complaint, illness, problem, or disease, the physician's assessment, diagnosis and/or treatment and any other important information which the physician decides to include. The medical transcriptionist and/or voice recognition technology produces electronic text of the physician's dictated information. In addition to this most common way of translating the original voice format of the notes into electronic text, the physician may directly enter his or her information or notations into an electronic medium. In fact, some computer software programs make it possible for a physician to enter data into specific fields from which an electronic notation resembling a professional transcription is produced. In accordance with the present invention, the information provided by the physician must be placed into a format that can be quickly sent to a research engine 4. This format may be electronic text or other formats known to those of skill in the art. This step of the process may be performed by a transcriber 3. Alternatively, the transcriber 3 may be unnecessary if the physician 2 forwards the information directly to the research engine 4. For example, the process of transcription could be skipped entirely if the original dictation is sent electronically as a sound file. Thus, it is important that the information provided by the physician be placed in a format which can be understood by the research engine 4. In one preferred embodiment, a professional transcriber 3 accomplishes this function; however, as discussed above, other methods of providing the information to the research engine are contemplated by the scope of the present invention.

The second step is simply the transfer of the electronic text, transcription or other format to the research engine 4. This would preferably happen electronically, but is not limited to that means of communication should other efficient means be developed or used. For example, the transfer of this transcription could be by telephone, by wireless communication, via lasers or other communication methods known to those of skill in the art. Alternatively, the transcriber 3 and research engine 4 can be located in the same place or on a network to eliminate the need for the transfer C.

The next step comprises the actual research being conducted by the research engine 4. The research engine 4 could perform this service in many ways. Generally, the research engine 4 is preferably an entity whose function would be to provide the physician with relevant, pertinent and useful information that relates to the patent and/or problem described in the transcription C. This information might be found by humans using computers, by humans using other research tools such as libraries, or by computers alone. In one preferred embodiment, this research would be conducted by humans using computers as tools, but this does not rule out the possibility of employing software in the future that would perform the same function independently. In addition, a combination of humans and computer software may be used to obtain the most useful and pertinent information for the physician. Software currently exists that operates based on Natural Language Processing systems which have the ability to extract key words from text. With software such as this, it is possible for a computer to conduct research based on a transcription, without any human intervention. In addition, voice recognition software could be employed to create the transcription thus eliminating the need for a human transcriber 3.

The research engine 4 would most likely be a separate entity such as a company comprising medical librarians and/or other experts specializing in medical research. Upon receipt of a transcription, B′ or C, a librarian would quickly conduct research on key pertinent information relating to the patient/problem described in the transcription, and send this information to the physician 2. In another embodiment, however, a computer system would automatically receive the transcription, perform the search, and send the relevant, pertinent information back to the physician 2. Human monitoring would still most likely be necessary in this embodiment to assure that a high quality product be returned to the physician 2.

Currently, one of the most efficient resources for medical research is the Internet and its vast array of on-line databases. Databases such as those provided by the Cochrane Library, the American College of Physicians, and the British Medical Journal Publishing Group are valuable sources of information. On-line resources such as these provide recent evidence-based information in the form of essays, scientific research and other forms of literature. Other types of databases found on the Internet are those created by the National Standard Organizations, which contain guidelines and standards that help physicians provide optimal care to patients. In addition to researching current medical information, the research engine 4 may find relevant historical, background or foundational information which is highly valuable to the physician 2. Moreover, the research engine 4 can access current recommendations, standards, guidelines and requirements of a physician's employer or group which defines the way a particular problem is to be handled (e.g., a man of age 50 should be sent to a specific physician for colonoscopy; a hospitalized patient with Community Acquired Pneumonia needs a follow-up chest x-ray within six weeks; the preferred antibiotic treatment of a urinary tract infection in a female is for a specific number of days) and thus, the research engine 4 can provide the physician 2 with information from his or her local practice “authority” as well as relevant and pertinent information in the research engine databases.

Of course, as will be understood by those of skill in the art, the domain or database examined by the research engine 4 is not limited to medical papers on the Internet. Any data relating to any medical problem, condition or situation could be incorporated into the research results. For example, a medical organization may have its own unique description of how a particular problem should be handled (typically called a practice guideline). This “private” data could be accessed and stored for delivery just to those physicians associated with the organization. Examples of such information include guidelines for prostate specific antigen (PSA) testing in men over 50, periodic eye exams for diabetics, referral to a particular doctor or group for sports injuries, and requirements for specific drugs for certain conditions.

In the preferred embodiment, a medical research engine 4 would use multiple sources for research, and compile relevant and pertinent information for use by the physician 2. Preferably, the research engine 4 would continually update its databases by accumulating additional information as soon as it becomes available. Of course, the larger the database that the research engine 4 can pull from, the higher the likelihood that the physician 2 will be provided with relevant and pertinent information to treat the current patient as well as patients in the future.

The information found by the research engine 4 may take the form of electronic text, such as web pages, photocopies of articles from medical journals, etc. Due to the large volume of information that is available on any one subject in the medical field, the research engine 4 would preferably exercise discretion as to the importance and relevance of each item of information found. For instance, if no new findings have occurred in the last twenty years on a specific illness outlined in a transcription, then it may be futile to send all the old research to a physician who has most likely been educated on the issue previously. In addition, since the average physician sees 20 to 30 patients a day, that could result in a great deal of reading material for the physician each following day. Therefore, the amount of information actually sent back to the physician by the research engine would most likely be limited to some degree, to avoid overloading of reading material. The details of how this would be limited can be resolved between the physician and/or hospital and the research engine.

The fourth step of the process is simply the transfer of the information found by the research engine 4, along with the transcription on which the research was based, back to the physician 2 in a timely fashion. This preferably occurs via electronic means, but is not limited to that means of communication. In fact, the physician 2 may arrange for another method of obtaining the researched information. For example, the physician may request that the researched information be posted on a website which could be viewed over the Internet by a physician with a password, or the researched information could be transmitted by facsimile or even by a voice message. In the preferred embodiment, the researched information would be electronically attached to the physicians notation that prompted the research so that the note and the research could be viewed together by the physician.

The fifth and final step constitutes a way by which the physician receives the research in a timely and efficient manner. If the information is sent directly to the physician electronically, the physician could be notified on a computer screen by means of a pop-up window or similar device. This pop-up window may list the headlines for found articles relevant or pertinent to the notations that were researched. It may also list a summary of each block of research assembled by the research engine. For instance, a summary could be posted such as “New Information Found Regarding the Treatment of Corneal Abrasions” which would give the physician an indication of the scope of the available information. The physician would then have the option of reading the researched information immediately, or saving it attached to the transcription for later reference.

Another possibility for connecting the physician to the information identified by the research engine 4 would be via Internet websites. The research engine 4 could keep a user's only database for physicians to log into, with a password system for physicians to access their individual transcription research. Physicians could, for example, log on to the website each morning to read or download the transcriptions from the day before, at which time the physician could read the research findings.

By incorporating such a system for automated delivery of patient-specific information and education into the medical field, there no doubt would be profound and immediate difference in many current practices. Physicians would continually be kept informed of the latest research and breakthroughs in the medical field, eliminating much of the need for continuing medical education courses. There would be improved consistency and uniformity in medical practice, as physicians are kept current on recent innovations. Finally, physicians could provide care that coincides with their community standards and that is “state-of-the-art”. By rapidly, routinely and automatically providing patient-specific information to physicians in association with their documentation of a patient's care, the quality of medical services would improve dramatically. If adopted by the medical field as a whole, the advent of such an educational and information delivery method could likely become the single most important breakthrough in medical history.

Although the present invention has been described in connection with the medical field, the preferred methods described herein are also applicable in other fields. For example, in the legal field an attorney could dictate a legal brief and forward the dictation to the transcriber. After transcription, a research engine could look for opinions decided by judges which would impact the brief and return those opinions or summaries thereof along with the transcription to the attorney. Likewise, accountants may develop a financial or tax plan which may be sent to a research engine. The research engine could look for relevant information or articles regarding the financial or tax plan and return the plan along with relevant or pertinent information to the accountant for review. As will be easily understood by those of skill in the art, the present method has broad applicability and use of the methods described herein in other fields is specifically contemplated as being within the scope of the present invention.

Although this invention has been disclosed in the context of certain preferred embodiments, it will be understood by those skilled in the art that the present invention extends beyond the specifically disclosed embodiments to other alternative embodiments and/or methods of use of the invention and obvious modifications and equivalents thereof. Thus, it is intended that the scope of the present invention herein disclosed should not be limited to the particular disclosed embodiments described above, but should be determined only by a fair reading of the claims that follow.

What is claimed is:

1. A method of providing physicians or other care givers with relevant, pertinent and specific information about a patient's problem or treatment comprising the steps of:
recording of a specific patient's information by a physician;
transmitting the patient information to a medical research engine to locate and provide relevant and pertinent information regarding the problems, diagnosis or treatment of the patient; and
transmitting the relevant and pertinent information to the physician so that the physician may implement whatever action is needed, if any.

2. The method of claim 1, including the step of transmitting the patient information to a transcribing service, which in turn transmits the transcribed information to said research engine.

3. The method of claim 2, including the step of transmitting the research engine information back to the transcribing service to be sent to the physician with the transcribed information.

4. The method of claim 1, wherein said recording step comprises dictating the patient information into a dictation device.

5. The method of claim 2, wherein said transmitting of information from the transcribing service to the research engine is performed electronically.

6. The method of claim 2, wherein said patient information is transferred electronically to said transcribing service.

7. The method of claim 1, wherein said transmitting of research information to the physician includes transmitting that information electronically.

8. A method of transferring patient-specific information to a physician or healthcare provider comprising the steps of:
having a physician develop information regarding a patient;
storing that information in a communication device; and
transferring the stored information to a research engine, wherein said research engine analyzes said stored information, obtains patient-specific information and forwards the stored information and the patient-specific information to the physician to assist the physician care for the patient.

9. A method for a patient to receive improved medical services comprising the step of:
conveying information to a healthcare provider;
recording the information along with the healthcare provider's analysis on a fixed medium;
transferring the fixed medium to a research engine which attaches patient-specific information to the fixed medium, returning the fixed medium and patient-specific information to the healthcare provider; and
permitting the healthcare provider to consider the patient-specific information in the continued care of the patient.

10. A method of delivering up-to-date patient specific information to a physician comprising the steps of:
having a specific patient meet a physician, the physician preparing a diagnosis as a result of the meeting;
transmitting the diagnosis to a research engine;
conducting research in connection with the diagnosis;
preparing a research report based on the research;
transmitting the diagnosis along with the research report to the physician to impact the patient's care and educate the physician.

11. The method of claim 10, further including the step of:
transcribing the diagnosis.

12. The method of claim 11, wherein the transcribing step and the conducting step occur at the same location.

13. The method of claim 11, wherein the transcribing step occurs prior to said conducting step.

14. The method of claim 10, wherein at least one of the transmitting steps occurs via a global communications network.
